(19) United States
(12) Patent Application Publication
(10) Pub. No.: US 2002/0066825 A1
(43) Pub. Date: Jun. 6, 2002

(54) Payload delivery system

(76) Inventors: Carlos T. Miralles, Tujunga, CA (US); Bart D. Hibbs, Altadena, CA (US)

Correspondence Address: LAW OFFICE OF JOHN A. GRIECCI, 2201 E. WILLOW ST, STE D, PMB 344, SIGNAL HILL, CA, 90806-2142, US

(21) Appl. No.: 09/884,852

(22) Filed: Jun. 18, 2001

Related U.S. Application Data
(63) Continuation-in-part of application No. 29/121,810, filed on Apr. 13, 2000.

(51) Int. Cl. B64C 3/56

(52) U.S. Cl. 244/49

(57) ABSTRACT

Disclosed is a spacecraft carrying a number of pods, each containing an aircraft that has been folded to fit in the pod. Each aircraft has a vertical stabilizer and outboard wing-portions that fold around fore-and-aft axes. Each aircraft also has a fuselage that folds around a lateral axis. The spacecraft releases one or more of the pods into an atmosphere. Each of the pods is configured with an ablative heat shield and parachutes to protect its aircraft when the pod descends through the atmosphere. The pod releases its aircraft at a desired altitude or location, and the aircraft unfolds while free-falling. The aircraft then acquires and follows a flight path, and activates scientific experiments and instruments that it carries. The aircraft relays results and readings from the experiments and instruments to the spacecraft, which in turn relays the results and readings to a mission command center.

This application is a continuation-in-part of U.S. patent application Ser. No. 29/121,810, which is incorporated herein by reference for all purposes.

The present invention relates to a payload delivery system. More particularly, the present invention relates to a drop vehicle configured for airborne flight-configuration deployment.

### BACKGROUND OF THE INVENTION

Payload delivery systems are used to deliver a payload, either to a target location, or along a target pathway, or both. Airborne payload delivery systems are frequently used to deliver payloads to targets located in inhospitable or hard-to reach locations.

Payload delivery systems must be designed with support structures and control systems that are adequate to deliver the payload in a manner that meets the physical and environmental needs of the payload. At the same time, payload delivery systems are preferably limited in size and weight, so as to minimize the carrying requirements on any launch system that is to deliver the payload delivery system to its destination (if a separate launch system is needed). This is particularly important if the payload delivery system is to be transported in space, which has high costs associated with cargo size and weight.

It is known to use an aircraft to drop parachute-equipped boxes of supplies to people in regions where landing is not easily accomplished. It is likewise known for a spacecraft to send a probe into a planet's atmosphere, with or without a parachute, where the probe is equipped with scientific instruments that take readings as the probe descends through the atmosphere. These are examples of payload delivery systems, the first being partially manned (the aircraft is manned, but the boxes are not manned) and the second being unmanned (even if it was launched from a manned rocket).

Many payload delivery systems, while useful in particular circumstances, have limitations to their use in other circumstances. Some of these systems have limited accuracy on acquiring and reaching their targets. Others are too large, heavy or otherwise impractical for certain missions. Many payload delivery systems are not capable of accomplishing missions where the target is at very high altitudes, on other planets, or where the target is a pathway that covers extended distances.

There exists a definite need for a relatively size- and weight-efficient payload delivery system capable of delivering a variety of payloads to a given target location or flight path. Various embodiments of the present invention can meet some or all of these needs, and provide further, related advantages.

### SUMMARY OF THE INVENTION

The invention provides a payload delivery system for delivering a payload to a target. It preferably offers a relatively efficient system, capable of delivering a variety of payloads to a given target location and/or flight path.

The invention includes an aircraft that defines flight vertical, lateral and fore-and-aft directions. The aircraft is configured with one or more components selected from a group of components. The group of components includes a fuselage having a fore-and-aft length dimension, an empennage having a vertical height dimension, and a wing having a lateral wingspan dimension. The invention features the one or more components being configured to unfold from a folded configuration to a deployed configuration that substantially increases its associated distance (i.e., the fuselage length, the wingspan and/or the empennage height).

The aircraft is preferably configured to unfold while either hanging from a descending parachute or while structurally unsupported, such as while flying or freely falling through an atmosphere. Advantageously, this feature of the invention provides for the aircraft to be folded and stored in a small, volumetrically efficient space, and unfold after it has been released from that space and dropped to a flight-path target.

The invention also features a fuselage that includes a forward fuselage portion and an aft fuselage portion configured to deflect relative to each other when the fuselage unfolds from a folded configuration to the deployed configuration. In deflecting, the forward and aft fuselage portions preferably rotate approximately 180° relative to one another, in a substantially lateral fold-direction. Advantageously, this feature both reduces fuselage length and preferably places laterally wide portions of the empennage near the wing, thus efficiently placing wide components near each other.

The invention further features that the forward and aft fuselage portions fold such that the aft fuselage portion primarily resides underneath the forward fuselage portion. This feature, in combination with the previous feature, advantageously places a horizontal stabilizer in a plane substantially parallel to that of the wing (without considering dihedral) to further add volumetric efficiency to the folded size of the aircraft.

The invention further features outboard wing portions that fold approximately 180° preferably in a completely, or at least substantially, horizontal rotational direction. Preferably the outer wing portions fold under an inboard portion of the wing. The invention also features an empennage that folds down, preferably by approximately 90° into a substantially horizontal plane. These features add to the volumetric efficiency of the folded aircraft.

Advantageously, the invention features a pod configured to contain the folded aircraft and to release it when it reaches a designated release location that allows the aircraft to acquire and reach a desired flight path and/or a desired destination. The pod is configured to protect the aircraft until it reaches the release location. The invention further includes a vehicle, such as a projectile, a rocket, an airplane, a satellite, spacecraft or the like, to deliver the pod to, and drop the pod from, a drop location above the release location, such that the pod can guide the aircraft from the drop location to the release location. The vehicle can be configured to carry a multitude of pods, each containing a payload, which could be of a wide variety of types, and could be the payload delivery system itself.

Advantageously, these features provide for the aircraft to be positioned to reach a desired target from a starting place that could be almost any distance away. Additionally, the efficient design provides for the delivery of a multitude of payloads to a variety of locations with only one launch vehicle, minimizing the weight of the overall system.

Other features and advantages of the invention will become apparent from the following detailed description of the preferred embodiments, taken in conjunction with the accompanying drawings, which illustrate, by way of example, the principles of the invention. The detailed description of particular preferred embodiments, as set out below to enable one to build and use an embodiment of the invention, are not intended to limit the enumerated claims, but rather, they are intended to serve as particular examples of the claimed invention.

### BRIEF DESCRIPTION OF THE DRAWINGS

FIG. 1 is a view of a preferred embodiment of a payload delivery system embodying the invention, the preferred embodiment including an aircraft and an aeroshell/pod, the aircraft being depicted in an unfolded, flight configuration, the pod being depicted in a closed configuration.

FIG. 2A is a cutaway, elevational view of the embodiment depicted in FIG. 1, the aircraft being depicted in a folded and stowed configuration within the pod, and the pod being depicted as translucent to show additional details of the stowed aircraft.

FIG. 2B is a perspective view of the embodiment depicted in FIG. 2A.

FIG. 2C is a plan view of the embodiment depicted in FIG. 2A.

FIG. 3 is a top view of the aircraft depicted in FIG. 1, the aircraft being depicted in an unfolded configuration, and including an indication of the pod's size and location, when the aircraft is stowed, superimposed on the aircraft, the pod's location being shown relative to a forward fuselage portion of the aircraft.

FIG. 4 is a perspective view of the aircraft depicted in FIG. 1, the aircraft being depicted in a partially unfolded configuration.

FIG. 5 is a perspective view of the aircraft depicted in FIG. 1, the aircraft being depicted in a fully folded configuration.

FIG. 6 is a perspective view of a payload delivery system including a spacecraft, and a plurality of the payload delivery systems depicted in FIG. 1.

FIG. 7 is time-series view of the payload delivery system depicted in FIG. 1, including an aircraft, shown descending through an atmosphere.

FIG. 8 is a perspective view of the aircraft depicted in FIG. 8, shown as its components are deploying.

FIG. 9 is a cross-sectional perspective view of the aircraft depicted in FIG. 8, shown with its components fully deployed.

FIG. 10 is a system diagram of a flight control system and related science and communication system in the aircraft depicted in FIG. 1.

### DETAILED DESCRIPTION OF THE PREFERRED EMBODIMENTS

The invention summarized above and defined by the enumerated claims may be better understood by referring to the following detailed description, which should be read in conjunction with the accompanying drawings. This detailed description of the preferred embodiments, set out below to enable one to build and use particular implementations of the invention, is not intended to limit the enumerated claims other than as set forth in the claims. Rather, it is intended to serve as a particular example thereof.

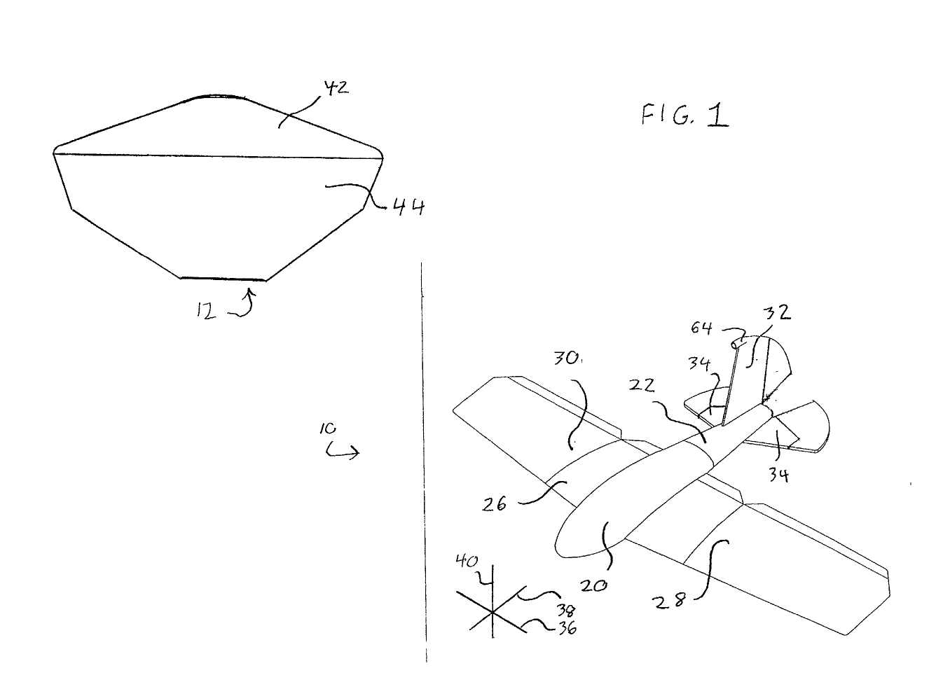

With reference to FIG. 1, a preferred embodiment of the invention is a system including an aircraft 10, which is preferably unpowered (i.e., a glider), and an aeroshell/pod 12. The aircraft defines lateral 36, for-and-aft 38 and vertical 40 directions that are typical for an aircraft reference frame. The pod includes an upper portion 42 and a lower portion 44.

The aircraft 10 includes a fuselage having a forward fuselage portion 20 and an aft fuselage portion 22, and being characterized by a fore-and-aft length. The aircraft also includes a wing having an inboard wing-portion 26, and port and starboard outboard wing-portions 28 and 30, respectively, the wing being characterized by a laterally measured wingspan. The empennage includes a vertical stabilizer 32 and a horizontal stabilizer 34, and is characterized by a vertical height and a laterally measured span. The fuselage, wing and empennage, with their associated distances of fore-and-aft length, lateral wingspan and vertical height, respectively, substantially characterize the overall dimensions of the aircraft. However, it should be understood that additional aircraft features, such as instrument pods, an undercarriage or landing gear, may add to the overall dimensions.

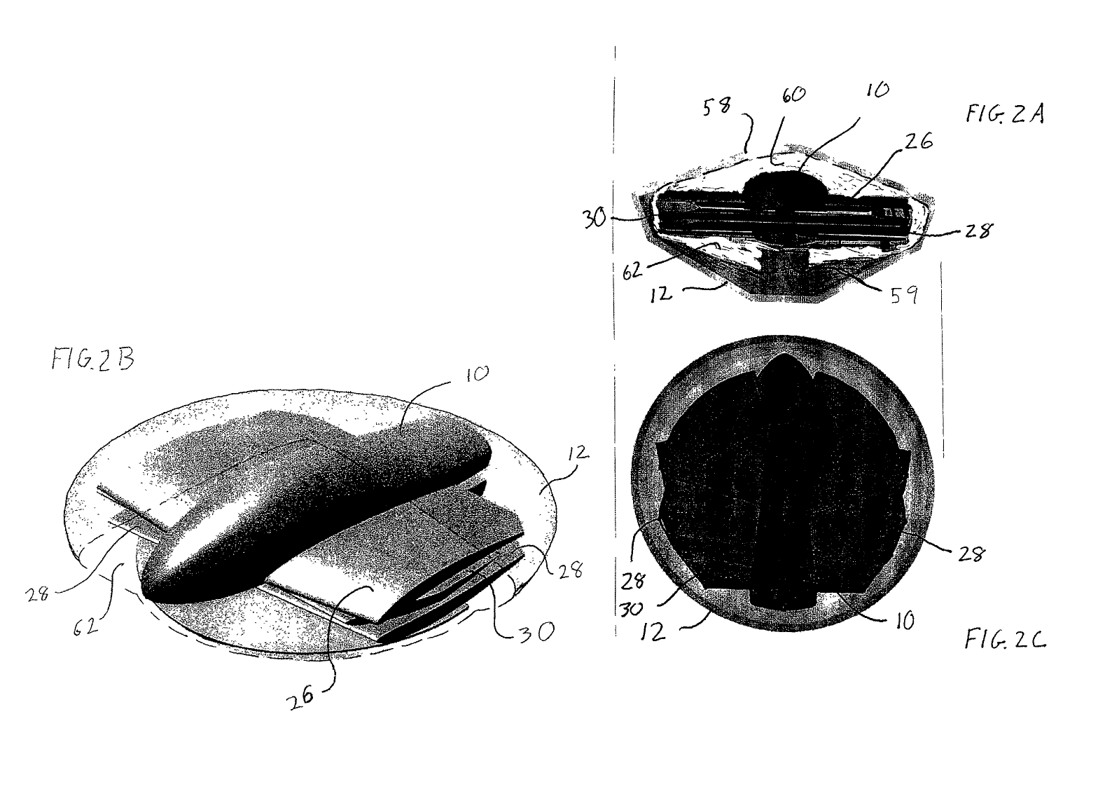

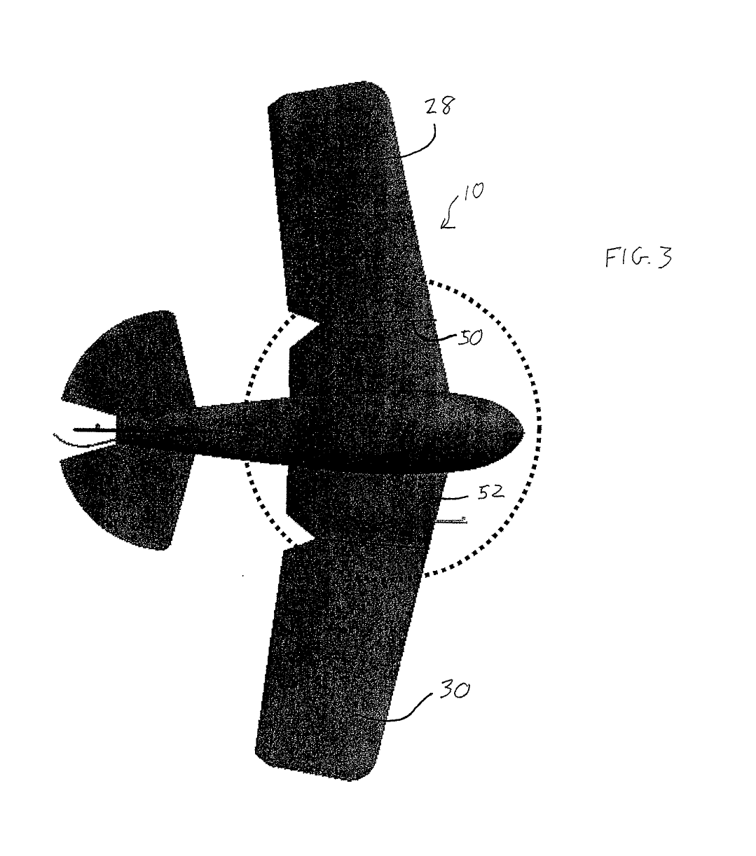

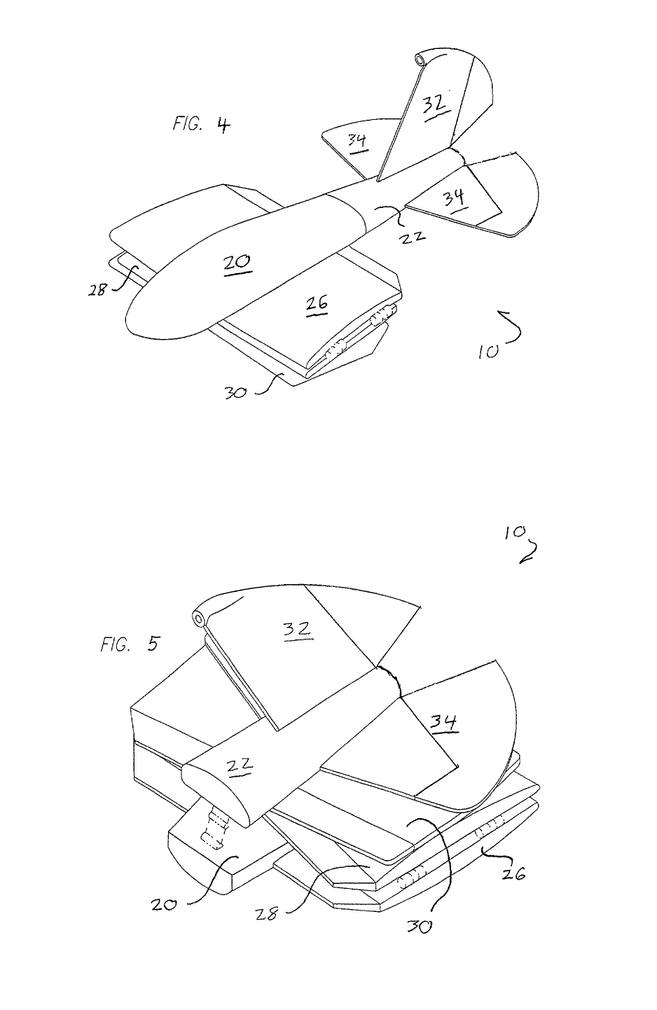

With reference to FIGS. 2A, 2B and 3, the aircraft 10 and pod 12 are configured such that the aircraft can be stored and carried within the pod. In particular, the port and starboard outboard wing-portions 28 and 30 are hingedly attached to port and starboard outboard edges, respectively, of the inboard wing-portion 26 by port and starboard hinges. These wing hinges preferably define port and starboard wing fold-directions, 50 and 52 respectively, preferably extending in a fore-and-aft direction so as to allow the outboard wing-portions to fold (i.e., hingedly rotate via the wing hinges around an axes extending in the fold-directions) in an approximately rolling motion. In alternate embodiments, the wing preferably folds in a fold-direction that is substantially in a horizontal plane (i.e., a plane normal to the vertical axis), such as a fold direction that is perpendicular to both the vertical axis and a local wing spar when the wing is swept. However, in other preferred embodiments the wing could fold in a fold-direction that is not substantially in the horizontal plane, and could even fold around a vertical fold-line.

Preferably the aircraft is a low-wing aircraft, such that the forward fuselage does not substantially impede the outboard wing-portions from folding to a substantially lateral configuration. Alternatively, the aircraft could be a high-wing aircraft and the outboard wing-portions could fold over the forward fuselage, again avoiding the forward fuselage substantially interfering with the outboard wing-portions' folding to a substantially lateral configuration.

The term hinge, as used in the present application, should be understood to include a wide variety of connectors that allow relative rotational movement, including ones that provide for both relative rotation and translation, and not just simple pinned rotational devices. The term fold-direction, as used in the present application, should be understood as defining a direction of rotation for a hinge rather than a fixed rotational axis that components rotate about. Thus, a component that both rotates and translates relative to another via a complex hinge can still be said to have a fold-direction that indicates the direction of the rotation.

Through the use of wing hinges, the outboard wing-portions can be folded from a stowed (i.e., folded) configuration (see, FIGS. 2A and 2B) extending laterally underneath the inboard wing-portion and forward fuselage portion to a deployed configuration (see, FIGS. 1 and 3). In this stowed configuration, the outboard wing-portions preferably extend in a substantially lateral direction to cross under the forward fuselage portion.

A fuselage hinge connects the forward fuselage portion 20 and the aft fuselage portion 22 along a fuselage fold-direction 54, allowing the aft fuselage portion to fold (i.e., hingedly rotate via the fuselage hinge) from a deployed configuration (see, FIGS. 1 and 3) to a stowed configuration (see, FIGS. 2A and 2B) underneath the forward fuselage portion (with respect to the forward fuselage portion) and preferably underneath the folded outboard wing-portions 28 and 30. The fuselage fold-direction preferably extends in a substantially lateral direction so as to allow the empennage to fold with an approximately pitching motion. In the folded configuration, the aft fuselage portion preferably extends in a substantially fore-and-aft direction under the forward fuselage portion.

The vertical stabilizer 32 is attached to the remainder of the aft fuselage portion 22 via an empennage hinge 56, allowing the vertical stabilizer to be unfolded from a folded configuration to a deployed configuration. The empennage hinge preferably defines a fold-direction extending in a relatively fore-and-aft direction so as to allow the empennage to fold in an approximately rolling motion. In the folded configuration, the vertical stabilizer extends laterally rather than vertically with respect to the remainder of the aft fuselage portion. In alternative embodiments, other aircraft configurations could be used, such as a V-tail having an empennage hinge that folds both sides of the V-tail down to a substantially horizontal position.

When the vertical stabilizer, the outboard wing-portions and the aft fuselage portion are in the folded configuration relative to the forward fuselage portion, the wing and fuselage hinges, and various portions of the aircraft, are preferably configured such that the folded outboard wing-portions 28 and 30 reside between the forward fuselage portion and the aft fuselage portion. The inboard wing-portion, outboard wing-portions, vertical stabilizer and horizontal stabilizer all preferably extend in a lateral direction. The horizontal stabilizer, which has a lateral span approximately equal to the lateral span of the inboard wing-portion, is substantially underneath the inboard wing-portion so as to minimize the extension of one outside the lateral and fore-and-aft extension of the other.

The aircraft is thus configured with a substantially reduced length, width and height as compared to the flight configuration (i.e., the configuration with the components in the deployed configurations). In particular, it is configured to fit inside of the pod, as depicted in FIGS. 2A, 2B and 3. Additionally, the vertical and horizontal stabilizers are preferably configured to have large surfaces, including large control surfaces, with arc-shaped trailing edges that substantially conform to the shape of the pod when the aircraft is stowed in the pod.

Preferably the aircraft fits in the pod while its components are in the folded configuration, but not while they are in the deployed configuration. In particular, the fuselage has a substantially smaller fore-and-aft fuselage-length in the folded configuration than in the deployed configuration, the wing has a substantially smaller lateral wingspan in the folded configuration than in the deployed configuration, and the empennage has a substantially smaller vertical empennage-height in the folded configuration than in the deployed configuration.

The above-described hinges can be any of a wide variety of hinge types, depending on the size and loading requirements of the hinge. Indeed, at least some of the hinges may be configured such that the hinge's connecting components become separated when placed in the deployed configuration. For example, in FIGS. 2A and 2B, the inboard wing-portion 26 and port outboard wing-portion 28 are depicted as separated, with the hinge extending between them. The use of various hinge types is within the anticipated scope of the invention.

With reference to FIGS. 1, 2A-2C, the pod is preferably configured with an outer surface that is rotationally symmetric around a vertical axis (i.e., its outer surface has a circular shape in any horizontal cross-section. The upper pod portion 42 and lower pod portion 44 separate at a circular opening to expose an interior chamber of the pod. The upper pod portion has an outer surface 58 that is a heat shield, i.e., it is shaped and otherwise configured with an ablative coating to protect the contents of the pod from heat during a descent through an atmosphere with the upper pod portion facing down into the descent. The lower pod portion is configured with one or more deployable parachutes 59 so as to aid in orienting the pod and/or slowing the pod during a descent. In alternative embodiments, the lower pod portion could include a heat shield and the upper pod portion could include a parachute, or only one of the pod portions could include one or both of these features.

The upper and lower pod portions 42 and 44 have upper and lower chamber surfaces, 60 and 62 respectively, that combine to form a pod inner chamber when the pod portions are joined to form the pod 12. When the vertical stabilizer, the outboard wing-portions and the aft fuselage portion are in their folded configurations, the aircraft is configured with a longitudinal length and a lateral width that are similar. The length, width and height of the aircraft with all components in the folded configuration are small enough to fit within the pod inner chamber.

In using the above system to deliver a payload, the payload is preferably first affixed to the aircraft, and the aircraft components are folded to the folded/folded configuration, and then the aircraft is provided for loading in the pod. In particular, to load the aircraft 10 into the pod 12, the outboard wing-portions 28 and 30 are folded to be relatively underneath the inboard wing-portion 26 (see, FIG. 4). The aft fuselage portion 22 is folded to be relatively underneath the forward fuselage portion 20, and the vertical stabilizer 32 is folded to extend substantially laterally, which is generally parallel to the horizontal stabilizer 34 (see, FIG. 5). Depending on the configuration of the embodiment, the order of folding could vary.

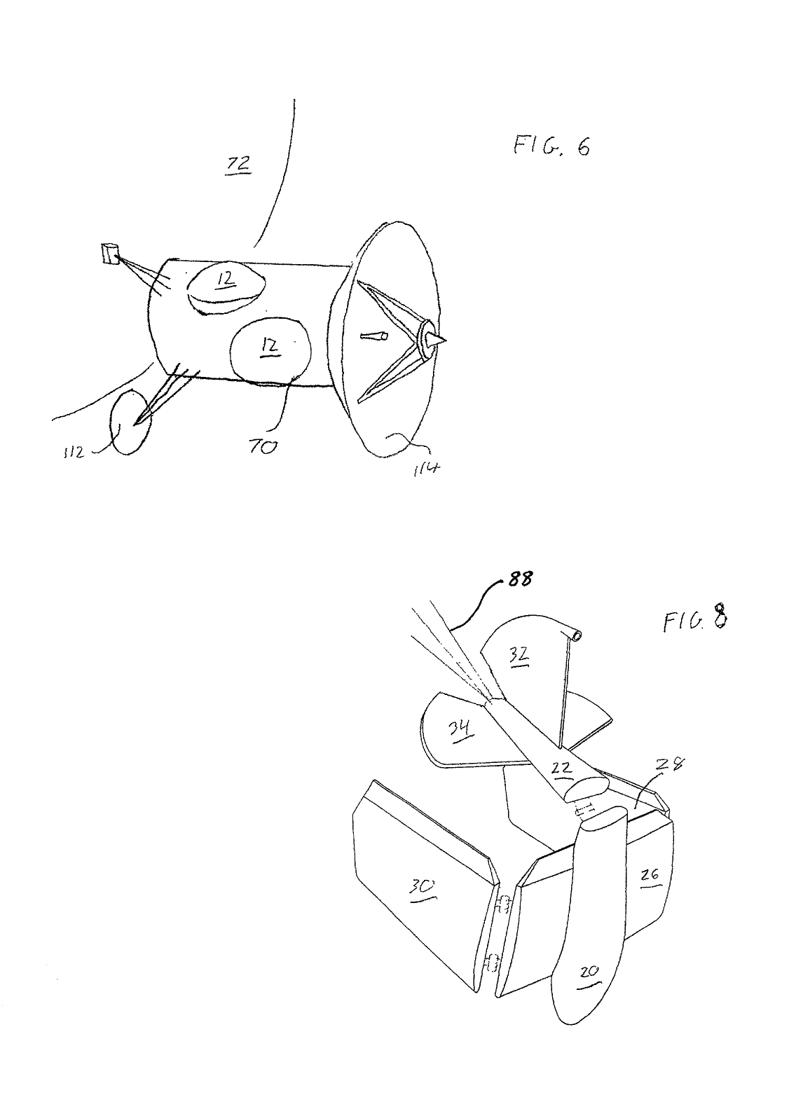

The folded aircraft with its affixed payload is then placed in the pod, and the pod is closed and sealed. With reference to FIGS. 2A and 6, one or more closed and sealed pods 12, each containing an aircraft 10 with its components in the folded configuration, can then be loaded on a launch vehicle system such as a larger aircraft, a rocket or a spacecraft 70. Each aircraft 10 can carry a payload of the same or similar equipment, such as a set of sensors, or each aircraft 10 can carry different types of mission-specific equipment. Each aircraft preferably includes accommodations for the operational needs of the sensors or other payload. For example, the aircraft can include a camera mount 64 in a location appropriate for a camera to view, such as on the upper end of the vertical stabilizer (depicted in FIG. 1).

The spacecraft 70 can be launched and orbited around a planet 72 while carrying one or more of the aircraft-containing pods 12. Sometime (preferably) after the spacecraft has been inserted into orbit, one or more of the pods can be released and dropped into the atmosphere. The release can occur on a preprogrammed schedule, or it can occur based on transmitted commands that are made in response to newly formed requirements. For example, the pod of an aircraft carrying weather-sensing equipment could be released when interesting weather conditions develop. Likewise, information sensed by a first aircraft could be used to determine when and where a pod containing a second aircraft would be released.

The release of the pod 12 will typically include some type of launching event to de-orbit the pod into the atmosphere, such as via thrusters or a launching mechanism, causing it to leave the spacecraft's orbit and descend into the planet's atmosphere below. However, if the spacecraft has a trajectory leading into the atmosphere, aerobraking can deorbit the pod. The pod will preferably descend at an established entry heading and descent angle, and it will preferably sense its roll orientation and/or rate. The upper pod portion's outer surface 58 is oriented downward during the descent, such that its outer surface's shape and ablative coating help to protect the aircraft from the heat developed during descent.

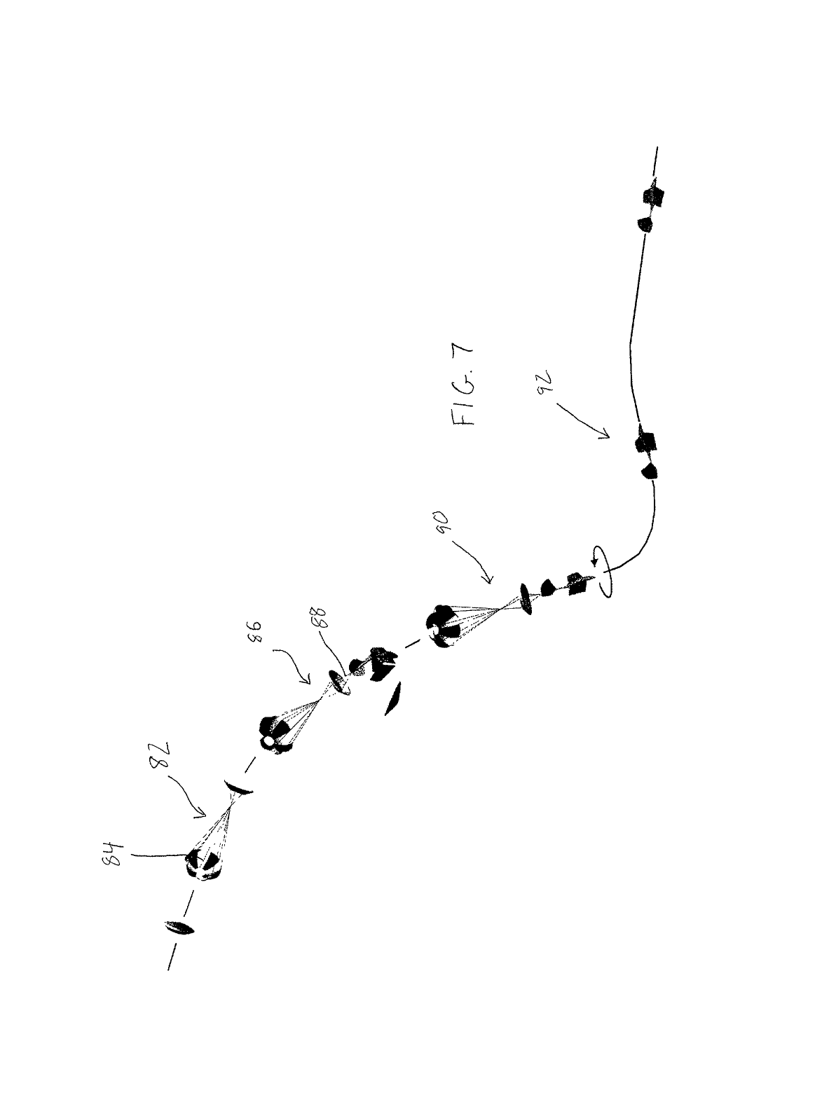

With reference to FIG. 7, at a given point 82 in the pod's descent, the pod 12 deploys its one or more parachutes 84 so as to slow the descent, control the angle of descent, and/or provide a separation load between the upper and lower pod portions 42 and 44. Upon reaching a desired condition 86, which could include a selected time, altitude, descent rate, temperature, pressure or other factors that can be sensed, a disconnect mechanism is activated, disengaging whatever type of seal and/or latching mechanism the upper and lower pod portions are connected with.

At this point, the upper pod portion is ejected from the lower pod portion, preferably under the loading and/or control of the parachutes and/or internal actuators. This separation of the pod portions preferably releases the aircraft 10 in its folded configuration from the pod. Thus, gravity, momentum and/or ejection mechanisms cause the aircraft to separate from the upper and lower pods, but a tether 88 connects the lower pod portion to the aircraft's empennage, allowing the aircraft to hang suspended from the lower pod portion.

The aircraft preferably includes actuation mechanisms to actuate and deploy the various components of the aircraft from their stowed configurations to their flight (i.e., deployed) configurations, most preferably while the aircraft is either hanging from the lower pod portion (and deployed parachute) or falling, structurally unsupported in an atmosphere (e.g., while in freefall and/or flight). These actuation mechanisms could include such active components as actuator motors to drive the components through their unfolding and/or folding motion, or active control surfaces to aerodynamically drive the components into place. Likewise, these actuation mechanisms could include passive systems such as spring-loaded hinges or natural aerodynamic drivers. For example, the fuselage hinge could be actuated by allowing the aircraft to fall freely, as the horizontal stabilizer catches the atmosphere, causing the aft fuselage portion to be whipped around into the flight configuration.

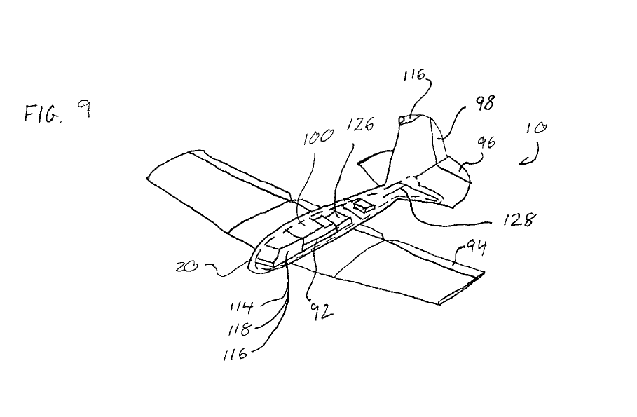

Preferably as the aircraft 10 hangs from the lower pod portion, each hinged fold on the aircraft includes servo actuators that control and/or urge the aircraft components from a folded configuration into a deployed (i.e., unfolded) configuration. As depicted in FIG. 8, the vertical stabilizer 32 preferably unfolds relative to the horizontal stabilizer 34 quickly to help establish and maintain the proper orientation of the aft fuselage portion 22 during descent. The fuselage-empennage fold preferably unfolds prior to, or more quickly than, the outboard wing-portions 28 and 30 to more quickly establish a forward fuselage portion 20 nose-first descent, and to orient the inboard wing-portion 26 such that aerodynamic forces encourage (or resist less) the unfolding of the outboard wing-portions.

Preferably, the aircraft includes locking mechanisms configured such that the components all lock in their deployed configurations. Nevertheless, the hinge folding directions are preferably configured such that conventional aerodynamic forces hold the hinges in the extended, deployed configurations without the aid of the locking mechanisms (e.g., the empennage and outboard wing-portions fold down with respect to the forward fuselage). Thus, the aircraft can be reliably used even in the case of a failure of a locking mechanism.

With the aircraft substantially unfolded 90, the aircraft extends its flaps from a neutral, storage position, to an extended position. Conventional control surfaces (e.g., ailerons) are used to orient the aircraft. The tether then releases and the aircraft executes a dive and pullout 92, retracting the flaps as appropriate when adequate airspeed is established.

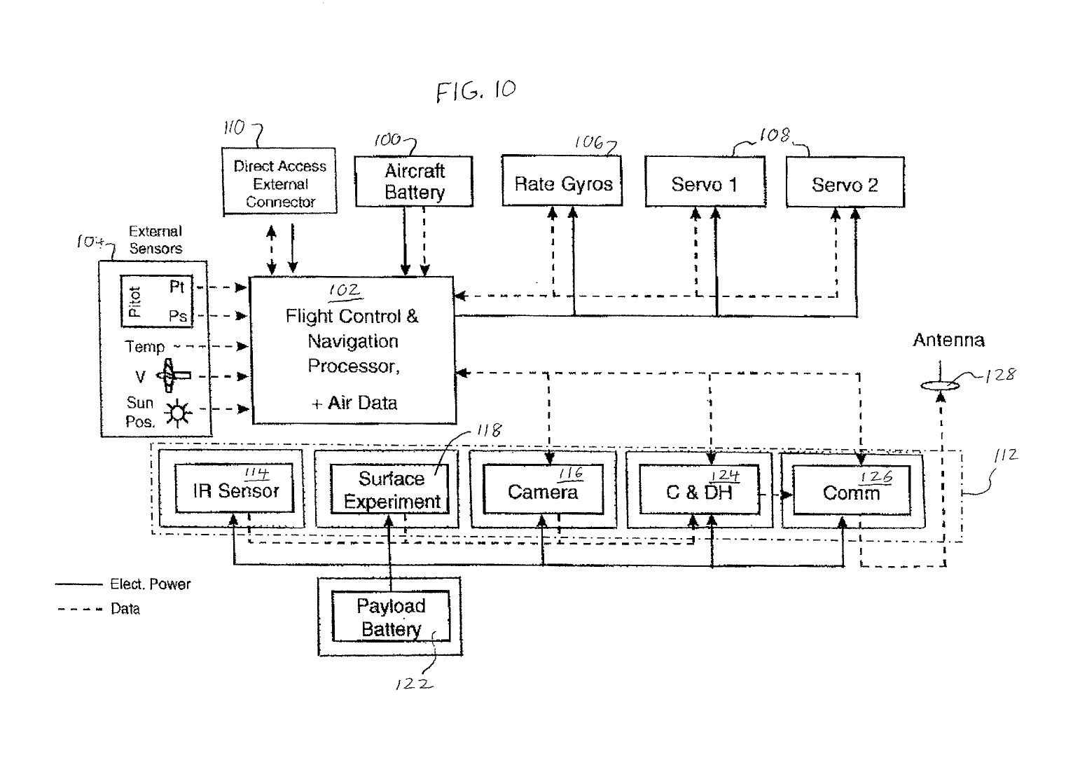

With reference to FIGS. 9 and 10, the size of the full wing, and the vertical and horizontal stabilizers are preferably large in comparison to standard aircraft designs so as to provide stability to recover from a wide variety of descent conditions, such as rolling and spinning. A flight control system on the aircraft 10 directs control surfaces such as ailerons 94, elevators 96 and a rudder 98 to correct the aircraft's roll angle, pull out of a dive, correct any residual yawing, and achieve substantially level and controlled flight, preferably (but not necessarily) in that order and/or concurrently. The flight control system preferably operates on power from an aircraft battery 100 stored in the forward fuselage portion 20.

The flight control system includes a controller 102 having a processor and data storage memory, external sensors 104, rate gyros 106 and servos 108. The controller receives information from the external sensors, which preferably include pressure sensors (for determining altitude and airspeed), temperature sensors, magnetic sensors, and optical sensors, as well as from the gyros. Using the information from the external-sensors and gyros, the controller instructs the servos to control and adjust the control surfaces. The flight control system also includes a direct access external connector port 110 for programming and testing the flight control system.

The payload preferably includes a science and communication system 112 that can have, for example, infrared sensors 114, cameras 116 and surface experiments 118. Optionally, the science and communication system can be operated by a second, payload battery 122. The science and communication system includes a C&DH (command and data handling) module 124 configured to manage the science and communication system.

When the aircraft 10 reaches a desired target, which could be a flight path through a target zone, a final resting place, or both, the science and communication system's sensors and/or experiments are activated by the C&DH module 124. The target could be determined relative to the spacecraft, relative to the planet itself, relative to people or equipment on the planet, or relative to planetary conditions such as storms.

Preferably, the controller 102 instructs the science and communication system on the timing of its operation, preferably via the C&DH module 124. Additionally, if desirable the controller 102 will report external sensor information to the science and communication system to be used by the surface experiments and/or transmitted out with science and communication system sensor readings via a communications module 126 having an antenna 128. Actual flight control information, such as aircraft responsiveness, gyro readings, controller errors, and the like, can also be reported by the controller to the science and communications system for transmission.

The signals transmitted by the communication module 126 are preferably received by a first antenna 112 on the spacecraft and transmitted to earth via a second antenna 114 on the spacecraft (see FIG. 6). Alternatively, the signals could be relayed via some other monitoring craft, or they could be received directly by a mission-control center (particularly if the mission occurs on earth).

While a particular form of the invention has been illustrated and described, it will be apparent that various modifications can be made without departing from the spirit and scope of the invention. For example, the payload could be of a wide array of types, each having potential variations on flight path and aircraft configuration. For example, payloads could be supplies to be delivered, chemicals to be released, or the like. Thus, although the invention has been described in detail with reference only to the preferred embodiments, those having ordinary skill in the art will appreciate that various modifications can be made without departing from the invention. Accordingly, the invention is not intended to be limited by the above discussion, and is defined with reference to the following claims.

We claim:

1. An aircraft defining flight vertical, lateral and fore-and-aft directions, comprising:
an airframe including a plurality of deployment hinges between a plurality of airframe portions that are configured to deflect relative to each other around hinge-lines of the deployment hinges to unfold from a folded configuration to a deployed configuration, the hinge-lines extending in a plurality of different directions;
wherein, in the deployed configuration, the airframe is configured to develop aerodynamic forces adequate for controlled flight when oriented in a flight orientation and moving in the forward direction at a flight speed;
wherein the airframe is characterized by a first set of maximum vertical, lateral and fore-and-aft dimensions when the airframe is in the folded configuration, and the airframe is characterized by a second set of maximum vertical, lateral and fore-and-aft dimensions when the airframe is in the deployed configuration, at least one of the maximum dimensions in the deployed configuration being significantly larger than its corresponding dimension in the folded configuration; and
wherein the aerodynamic forces that occur on the deployed airframe during controlled flight, when the airframe is oriented in a flight orientation and moving in the forward direction at a flight speed, load the deployment hinges in an unfolding direction.

2. The aircraft of claim 1, wherein:
the airframe comprises a fuselage extending in a fore-and-aft direction and a wing extending in a lateral direction;
the fuselage includes a first deployment hinge of the plurality of deployment hinges, the first deployment hinge defining a hinge-line extending in a substantially lateral direction; and
the wing includes a second deployment hinge and a third deployment hinge of the plurality of deployment hinges, the second and third deployment hinges defining hinge-lines extending in substantially fore-and-aft directions.

3. The aircraft of claim 1, the airframe comprising:
a wing including an inboard wing-portion, a port outboard wing-portion, and a starboard outboard wing-portion, the outboard wing-portions being configured to rotate relative to the inboard wing-portion such that the wing is configured to unfold from a folded configuration to a deployed configuration;
wherein, with the wing in the deployed configuration, the port outboard wing-portion extends substantially laterally outboard from a port side of the inboard wing-portion, and the starboard outboard wing-portion extends substantially laterally outboard from a starboard side of the inboard wing-portion; and
wherein, with the wing in the folded configuration, the port outboard wing-portion extends laterally inboard from the port side of the inboard wing-portion substantially to the starboard side of the inboard wing-portion, and the starboard outboard wing-portion extends laterally inboard from the starboard side of the inboard wing-portion substantially to the port side of the inboard wing-portion.

4. The aircraft of claim 1, wherein the aircraft is a glider.

5. A payload deployment system, comprising:
the aircraft of claim 1; and
a pod configured to contain the aircraft when the fuselage is in its folded configuration.

6. A method of deploying a payload through an atmosphere, comprising:
providing the aircraft of claim 1;
affixing the payload to the aircraft;
placing the aircraft, with the airframe in the folded configuration and with the payload, in a pod;
dropping the pod through the atmosphere;
releasing the aircraft with the affixed payload from the dropped pod;
actuating the airframe portions around the hinge-lines of the deployment hinges to unfold them from the folded configuration to the deployed configuration.

7. The method of claims 6, 17, and further comprising directing the aircraft to fly along a flight path through the atmosphere after it has been released.

8. The method of claims 6, 17, wherein the pod includes an ablative heat shield configured to protect its contents from heat when the pod is dropped through the atmosphere.

9. The method of claims 6, 17, wherein the aircraft is tethered to a portion of the pod, and further comprising:
deploying a parachute from the portion of the pod to slow the rate at which it is dropping; and
releasing the tether to cause the aircraft to fall from the portion of the pod after the airframe portions have unfolded from the folded configuration to the deployed configuration.

10. An aircraft defining flight vertical, lateral and fore-and-aft directions, comprising:
a wing including an inboard wing-portion, a port outboard wing-portion, and a starboard outboard wing-portion, the outboard wing-portions being configured to rotate relative to the inboard wing-portion such that the wing is configured to unfold from a folded configuration to a deployed configuration;
wherein, with the wing in the deployed configuration, the port outboard wing-portion extends substantially laterally outboard from a port side of the inboard wing-portion, and the starboard outboard wing-portion extends substantially laterally outboard from a starboard side of the inboard wing-portion; and
wherein, with the wing in the folded configuration, the port outboard wing-portion extends laterally inboard from the port side of the inboard wing-portion substantially to the starboard side of the inboard wing-portion, and the starboard outboard wing-portion extends laterally inboard from the starboard side of the inboard wing-portion substantially to the port side of the inboard wing-portion.

11. The aircraft of claim 10, wherein, with the wing in the folded position, the wing is symmetric across a plane defined by the fore-and-aft and vertical directions.

12. The aircraft of claim 10, and further comprising a fuselage, wherein:
the inboard wing-portion connects to the fuselage such that a substantial portion of the fuselage vertically extends on one vertical side of the inboard wing-portion, relative to the inboard wing-portion; and
with the wing in the folded configuration, the port and starboard outboard wing-portions are vertically located on the vertical side of the inboard wing-portion opposite the side on which the substantial portion of the connecting portion of the fuselage vertically extends, relative to the inboard wing-portion.

13. The aircraft of claim 12, and further comprising:
a fuselage including a forward fuselage portion and an aft fuselage portion configured to longitudinally extend fore-and-aft from each other when the fuselage is in a deployed configuration, the aft fuselage portion including an empennage portion;
wherein the forward and aft fuselage portions are configured to deflect relative to each other when the fuselage unfolds from a folded configuration to a deployed configuration; and
wherein, with the fuselage in the folded configuration, the outboard wing-portions are located between inboard wing portion and the empennage portion.

14. The aircraft of claim 10, wherein:
the aircraft is a low-wing aircraft; and
with the wing in the folded configuration, the port and starboard outboard wing-portions are located underneath the inboard wing-portion, relative to the inboard wing-portion.

15. The aircraft of claim 10, wherein the aircraft is a glider.

16. A payload deployment system, comprising:
the aircraft of claim 10; and
a pod configured to contain the aircraft when the fuselage is in its folded configuration.

17. A method of deploying a payload through an atmosphere, comprising:
providing the aircraft of claim 10;
affixing the payload to the aircraft;
placing the aircraft, with the wing in the folded configuration and with the payload, in a pod;
dropping the pod through the atmosphere;
releasing the aircraft with the affixed payload from the dropped pod;
actuating the outboard wing portions to rotate relative to the inboard wing-portion such that the wing unfolds from the folded configuration to the deployed configuration.

18. The method of claim 17, and further comprising directing the aircraft to fly along a flight path through the atmosphere after it has been released.

19. The method of claim 17, wherein the pod includes an ablative heat shield configured to protect its contents from heat when the pod is dropped through the atmosphere.

20. The method of claim 17, wherein the aircraft is tethered to a portion of the pod, and further comprising:
deploying a parachute from the portion of the pod to slow the rate at which it is dropping; and
releasing the tether to cause the aircraft to fall from the portion of the pod after the wing unfolds from the folded configuration to the deployed configuration.
